(19) United States
(12) Patent Application Publication
(10) Pub. No.: US 2022/0108480 A1
(43) Pub. Date: Apr. 7, 2022

(54) BIT PLANE DECODING METHOD AND APPARATUS

(71) Applicant: SZ DJI TECHNOLOGY CO., LTD., Shenzhen (CN)

(72) Inventor: Shizhuang LIU, Shenzhen (CN)

(73) Assignee: SZ DJI TECHNOLOGY CO., LTD., Shenzhen (CN)

(21) Appl. No.: 17/553,873

(22) Filed: Dec. 17, 2021

Related U.S. Application Data
(63) Continuation of application No. PCT/CN2019/092018, filed on Jun. 20, 2019.

(51) Int. Cl. G06T 9/00; G06T 3/40

(52) U.S. Cl. CPC G06T 9/00; G06T 3/40

(57) ABSTRACT

A bit plane decoding method can employ a “prediction plus reconstruction” process in bit plane decoding. By first-stage or multi-stage prediction, the position of at least some unwanted decoding may be omitted in the reconstruction process. The method can include obtaining a code block to be decoded, the code block comprising a plurality of stripes, each said stripe including a plurality of pixel positions to be decoded; performing an L-stage prediction on the plurality of pixel positions included in each said stripe to divide the plurality of pixel positions in each said stripe into a corresponding decoding channel, the decoding channel comprising an s-channel, an m-channel, or a c-channel, wherein L is an integer greater than or equal to 1; and decoding the pixel positions of each decoding channel to obtain wavelet coefficients for each pixel location.

### CROSS-REFERENCE TO RELATED APPLICATION

The present application is a continuation of International Application No. PCT/CN2019/092018, filed Jun. 20, 2019, the entire contents of which is incorporated herein by reference in its entirety.

### TECHNICAL FIELD

The present disclosure relates to the field of image decoding, in particular to a bit plane decoding method and apparatus.

### BACKGROUND

Joint Photographic Expert Group (JPEG) 2000 is a commonly used image compression standard. JPEG 2000 employs several core algorithms, such as discrete wavelet transform, bit plane coding, and entropy coding. Bit plane coding is used as a part of providing an embedded code stream, and the algorithm of bit plane coding may be complex. Bit plane decoding applies to image decoding as an inverse process for bit plane encoding. In the decoding process, it is determined whether each pixel point needs to be decoded in sequence in each encoding channel. For one decoding channel, portions of the pixel points of a code block typically need to enter the decoding channel for decoding, and other portions of the pixel points of the code block may not need to enter the decoding channel for decoding. Therefore, some pixel points that do not need to be decoded may still consume a relatively large amount of decoding time, which can limit the decoding speed.

### SUMMARY

Embodiments of the present disclosure provide a bit plane decoding method and apparatus, which can improve the decoding speed.

In an aspect of the present disclosure, a method of bit plane decoding is provided or implemented. The method can comprise: obtaining a code block to be decoded, where the code block can include a plurality of stripes, and where each stripe can include a plurality of pixel positions to be decoded; performing an L-stage prediction on the plurality of pixel positions included in each stripe to divide the plurality of pixel positions in each stripe into a corresponding decoding channel, the decoding channel including an s-channel, an m-channel, or a c-channel, wherein L≥1, and L is an integer; and decoding the pixel positions of each decoding channel to obtain wavelet coefficients for each pixel location.

In another aspect of the present disclosure, an apparatus for bit plane decoding is provided. The apparatus can have functionality to implement the method of the preceding aspect. The functions may be implemented in hardware or by hardware executing corresponding software implementations. The hardware or software can include one or more units corresponding to the functions described above.

In a further aspect of the present disclosure, an apparatus for bit plane decoding is provided. The apparatus can include a memory to store computer instructions, a processor to execute computer instructions stored by the memory, and to cause execution of computer instructions stored in the memory to cause the processor to perform a method in the aforementioned aspect or any possible implementation of the first aspect.

In a further aspect of the present disclosure, a chip is provided. The chip can include a processing module and a communication interface. The processing module can be configured to control the communication interface to communicate with an outside. The processing module further can be configured to implement a method in any possible implementation of the first aspect.

In a further aspect of the present disclosure, a non-transitory computer-readable storage medium can be provided. The non-transitory computer-readable storage medium can include a computer program stored thereon. When executed by one or more computers, the non-transitory computer-readable storage medium can cause the one or more computers to implement a method of the first aspect. In particular, the one or more computers may be the apparatus described above.

In a further aspect of the present disclosure, a computer program product containing instructions is provided. When executed by a computer, the computer program product can cause the computer to implement a method of the first aspect. In particular, the computer may be the apparatus described above.

### BRIEF DESCRIPTION OF THE DRAWINGS

The accompanying drawings, which are incorporated herein and form a part of the specification, illustrate implementations of the present disclosure and, together with the description, further serve to explain the present disclosure and to enable a person skilled in the pertinent art to make and use the present disclosure.

FIG. 1 illustrates a schematic diagram of a decoding process for JPEG 2000.

FIG. 2 illustrates a schematic diagram of a bit plane.

FIG. 3 illustrates a schematic diagram of a bit plane scanning process.

FIG. 4 illustrates a schematic diagram of a prediction process for an s-channel.

FIG. 5 illustrates a schematic diagram of a first-stage prediction process for an m-channel.

FIG. 6 illustrates a schematic diagram of a caching process for importance information of a second stage (i.e., marked information layer).

FIG. 7 illustrates a schematic diagram of a cache process for sign mark of the second stage.

FIG. 8 illustrates a schematic diagram of m-channel decoding using a lazy mode.

FIG. 9 illustrates a schematic diagram of m-channel and c-channel parallel decoding.

FIG. 10 illustrates a schematic diagram of a clock cycle decoding of four 4 pixel points.

FIG. 11 illustrates a schematic diagram of a parallel decoding process.

FIG. 12 illustrates a schematic diagram of a decoding plane and a non-decoding plane after a code block is decomposed into a bit plane.

FIG. 13 illustrates a schematic diagram of marking decoded and undecoded pixel points in a code block.

FIG. 14 illustrates a schematic diagram of adding correction value to a COEF coefficient.

FIG. 15 illustrates a flow diagram of adding a correction value to the COEF coefficient.

FIG. 16 illustrates a schematic block diagram of a decoding device according to one or more embodiments of the present disclosure.

FIG. 17 is a schematic block diagram of a decoder according to one or more embodiments of the present disclosure.

FIG. 18 is a block diagram of a decoder according to one or more embodiments of the present disclosure.

FIG. 19 is a schematic diagram of an internal structure of a BPD according to one or more embodiments of the present disclosure.

Implementations of the present disclosure will be described with reference to the accompanying drawings.

### DETAILED DESCRIPTION

Unless defined otherwise, all technical and scientific terms used herein have the same meaning as commonly understood by one of ordinary skill in the art to which this application belongs. The terminology used in the specification of the present application is for the purpose of describing particular embodiments only and is not intended to be limiting of the present application.

Aspects or embodiments of the disclosed subject matter can be applied to the field of image decoding, for example, the bit plane decoding of JPEG2000. For ease of understanding of embodiments of the present disclosure, the decoding process of JPEG2000 is first described.

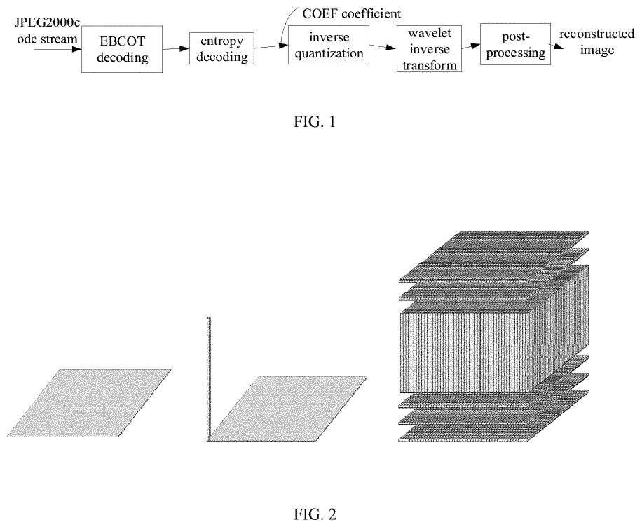

Referring to FIG. 1, FIG. 1 is a schematic diagram of a decoding process for JPEG2000. The decoding process of JPEG2000 may include obtaining a JPEG2000 code stream, embedded block coding with optimized truncation (EBCOT) decoding (e.g., with COEF coefficient), entropy decoding, inverse quantization, wavelet inverse transform, and post-processing, ultimately resulting in a reconstructed image. The EBCOT decoding can be the core algorithm of JPEG2000, which may be referred to or characterized as a bit plane-based decoding method.

Referring to FIG. 2, FIG. 2 is a schematic diagram of a bit plane. As shown in FIG. 2, an image can be used as a bottom surface, the pixel values of each pixel point of the image can be represented by a number of bits of binary digits, and a histogram may be formed. From the perspective of the cross-section, it is understood that this image is cut into a number of bit planes. In other words, the pixel values for each pixel point may be represented by a number of bits of binary digits. The values of the same bits of each pixel point can be sequentially taken out to form a bit plane. For example, if each pixel point of the image is represented by 32 binary bits, the image can be decomposed into 32 bit planes.

In EBCOT, wavelet coefficients for each code block can be decomposed onto different bit planes. In other words, each bit plane can be a bit value on a binary corresponding bit of each wavelet coefficient. It is understood that the magnitude and sign of the wavelet coefficients can be separated. The magnitude may also referred to as the COEF (or COEF coefficient), and the sign may also be represented as SIGN. It is also understood that, in embodiments of the present application, each of the wavelet coefficients can correspond to one pixel point, and each bit of the binary expansion of the wavelet coefficient can correspond to the location of this pixel point on this bit plane.

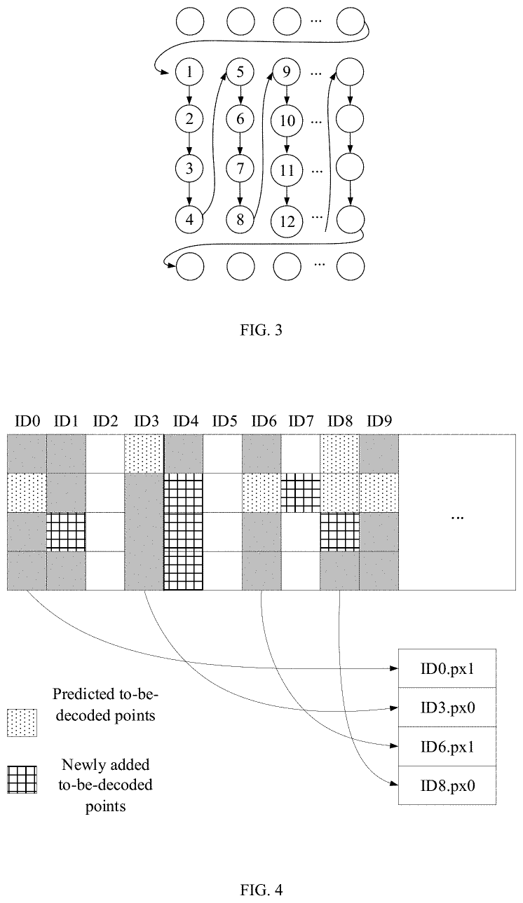

When each code block is scanned, the scanning can be performed, for instance, in units of 4-row, from the top-most wavelet coefficients on the left side of the code block. In each bit plane, each 4-row may be referred to as a stripe in each bit plane until all wavelet coefficients within the code block are scanned. A scanning process of the bit plane is shown in FIG. 3, which is a schematic diagram of a bit plane scanning process.

In addition, there can be eight neighborhood fields for each pixel location. As illustrated in FIG. 3, for instance, the eight neighborhood fields of pixel position 6 are pixel positions 1, 5, 9, 2, 10, 3, 7, and 11. And the eight neighborhood fields of pixel position 7 are pixel positions 2, 6, 10, 3, 11, 4, 8, and 12.

In encoding, for each code block, the plane can be encoded bit-by-bit from the non-zero most significant bit plane until the lowest bit plane. The bits on each bit plane can pass through a 3-pass scanning process, and the bits on one bit plane can be divided into three different coding channels according to a certain rule.

Three different coding channels can be a significant propagation pass, a magnitude refinement pass, and a cleanup pass, which may be simply referred to herein as s-Channel, m-Channel, and c-Channel, respectively.

In addition, the bits on the bit plane may enter which of the three coding channels described above is determined according to the following rules.

s-channel: The current pixel location may not be an important coefficient, but the 8 neighborhood fields of the pixel location can have coefficients of significant coefficients into the s-channel for encoding.

m-channel: The current pixel location has been a coefficient of significant coefficients into the m-channel for encoding.

c-channel: Other coefficients on the bit plane other than the coefficients entering the s-channel or the m-channel.

Here, whether a pixel location is an important coefficient may also referred to as an importance information for the pixel location.

According to the scanning process of the bit plane described above, it can be appreciated that in the course of scanning, there may be only partial pixel positions encoded by the channel for each channel, and therefore, when decoding, there are many pixel locations that do not need to enter the channel for decoding.

In order to reduce the latency and idle of these pixel locations that do not need to be decoded, the present application can provide a “prediction plus reconstruction” processing approach to the three channels described above.

The prediction of each of the three channels may be designed as a first-stage, a second-stage, or multi-stage, which is not limited in this application. In the following, only first-stage prediction may be adopted in the s-channel, and the m-channel and the c-channel can adopt second-stage prediction, as examples to illustrate the “prediction plus reconstruction” processing mode according to embodiments of the present application.

### 1. Prediction and Reconstruction of S-Channel

(1) Prediction of S-Channel

The size of the code block as illustrated below is 32×32. However, the size of the code block is not limited; for example, the size of the code block may also be 64×64 or some other size.

It is understood that 32×32 can represent an array of pixel locations that are 32 rows with 32 columns in size.

For a code block with a size of 32×32, the size of the stripe can be 32×4, where each stripe can be divided into 32 groups according to 1×4 (i.e., the size of each group is 1×4). According to the order from left to right, the importance mark before s-channel decoding can be taken as a basis, and whether the pixel position needing to enter the s-channel for decoding can be checked in each group.

It is understood that before s-channel decoding, the points that need to be decoded at the s-channel may be predicted based on the importance mark for each pixel location.

Since in the process of decoding and reconstruction, some points that need to be decoded may be newly generated, and therefore, the point at which the prediction may need to enter the s-channel may simply be part of the point that actually may need to be decoded in the s-channel.

Starting from the first stripe, operations can include finding the group of the first to-be-decoded points in the stripe according to the scanning order, recording the position information of the first to-be-decoded pixel positions in the groups from the left to the right, and writing the position information to the first input first output (FIFO) storage structure.

Referring to FIG. 4, FIG. 4 is a schematic diagram of a predictive reconstruction process for an s-channel. Using one stripe as an example, assuming that the first group of this stripe contains the to-be-decoded points as ID0, and the position of the first to-be-decoded point of ID0 can be ID0.px1. The next group of this stripe can contain the to-be-decoded points of ID3, and the position of the first to-be-decoded point of ID3 can be ID3.px1. The next group of this stripe can contain the to-be-decoded points of ID6, and the position of the first to-be-decoded point of ID6 can be ID6.px1. Sequentially scanned from left to right, and then the next group of this stripe can contain the to-be-decoded points is ID8, and the position of the first to-be-decoded point of ID8 can be ID8.px0. The position of the first to-be-decoded point of ID9 can be ID9.px0. The cases of each group after ID9 in the stripe is not shown in FIG. 4.

It is noted here that when recording the position of the to-be-decoded point in each group, it may be only necessary to record a point that conforms the condition that “the left neighboring pixel group does not predict the to-be-decoded point, but the current pixel group has predicted the to-be-decoded point.” Using the above-mentioned ID9 as an example, because ID8 on its left can present a point that predicts the need to decode, ID9 may not comply with the “the left neighboring pixel group does not predict the to-be-decoded point, but the current pixel group has predicted the to-be-decoded point” condition, and ID9 may not need to be recorded in the FIFO. In addition, using the above-mentioned ID8 as an example, ID8 conforms to the condition that “the left neighboring pixel group does not predict the to-be-decoded point, but the current pixel group has predicted the to-be-decoded point.” At the same time, since two to-be-decoded points can be included in ID8, their positions can be ID8.px0 and ID8.px1, respectively, and only ID8.px0 may be written to FIFO.

Hence, after the first 9 groups of stripe shown in FIG. 4 are scanned, the pixel positions written to FIFO can be sequentially as: ID0.px1, ID3.px0, ID6.px1, and ID8.px0.
(2) Reconstruction of S-Channel

The location information of a to-be-decoded point can be first read from the FIFO, and the context of this point can be calculated and decoded. The importance information and the sign mark of this point in the reconstruction process can be obtained according to the decoding result. In order to distinguish the importance information and sign mark for each point before the s-channel decoding reconstruction, the importance information and the sign mark for each point prior to decoding reconstruction may be referred to herein as the first importance information and the first sign mark. The importance information and the sign mark of the to-be-decoded point determined in the decoding reconstruction process of the s-channel may be referred to as the second importance information and the second sign mark.

The process of calculating the context may be according to convention and is not repeated herein.

The reconstruction process of the s-channel is described below.

According to the second importance information of the current decoding point and the first importance information within the reference range and other second importance information within the reference range, it can be predicted whether the group the current decoding point located, and the right adjacent group can contain other to-be-decoded points in the s-channel.

Here, the reference range may refer to the left adjacent group of the pixel group where the current decoding point is located, the right adjacent group, and the upper row of the stripe where the current decoding point is located.

If the group in which the current decoding point is located contains other to-be-decoded points in the s-channel, or there are other to-be-decoded points in the s-channel in the right adjacent group, then the points can be newly added to-be-decoded points in the s-channel during the s-channel reconstruction process. Operations can include finding the first to-be-decoded pixel points in these points, decoding these points at the next clock cycle, and continuing to predict other to-be-decoded points in the s-channel based on the second importance information of the point and the first importance information within the reference range and other second importance information within the reference range.

It is understood that the newly added to-be-decoded points may refer to the point where the prediction is to be decoded in the reconstruction process according to the first importance information and the existing second importance information within the reference range. The newly added to-be-decoded points can include the following 3 portions: (1) the point fails to be determined in the prediction phase; (2) the point that be predicted needs to be decoded but not written to the FIFO; and (3) the point predicted that needs to be decoded and written to the FIFO, but also be determined according to the first importance information and the existing second importance information within the reference range during the reconstruction process.

Using the stripe shown in FIG. 4 as an example, a to-be-decoded point can be read from the FIFO. According to the above description of FIG. 4, the first read pixel point should be ID0.px1. The context of ID0.px1 can be calculated and ID0.px1 can be decoded to obtain the second importance information of ID0.px1. According to the second importance information of ID0.px1 and the first importance information and the existing second importance information within the reference range, it can be predicted whether there is a newly added to-be-decoded points in the s-channel in the group where ID0.px1 is located (i.e., ID0) and the right adjacent group (i.e., ID1). As shown in FIG. 4, assuming that ID1.px2 in ID1 is determined needs to enter the s-channel for decoding, the point ID1.px2 can become the newly added to-be-decoded points in the s-channel.

Determining whether ID1.px2 is the next to-be-decoded pixel point of ID0.px1 stored in the FIFO. According to the prediction result of the s-channel described above, it may be known that in the to-be-decoded pixel point stored in the FIFO, the next pixel point of ID0.px1 is ID3.px0. ID3.px0 can be the first to-be-decoded pixel point in ID3.

According to the decoding order, the newly added pixel point ID1.px2 can be decoded at the next clock cycle. Specifically, the context of ID1.px2 can be calculated and ID1.px2 can be decoded to obtain the second importance information of ID1.px2. According to the second importance information of ID1.px2 and the first importance information and the existing second importance information within the reference range, it can be predicted whether there are new to-be-decoded points in the s-channel in the group ID1 in which ID1.px2 can be located and the in the right adjacent group ID2. If there are no new to-be-decoded points in the s-channel in the group ID1 or ID2, a new to-be-decoded point can be read from the FIFO to continue the decoding process. Thus, ID3.px0 can be decoded in the next clock cycle after decoding the ID1.px2.

It should be noted that when there are multiple pixel points in a group adjacent to the right side need to enter the s-channel for decoding, the decoding can be performed one-to-one according to the decoding order. For example, in FIG. 4, ID4.px1, ID4.px2, and ID4.px3 within ID4 can be predicted to be decoded into the s-channel according to the decoding result of ID3.px0. In the next clock cycle, ID4.px1, ID4.px2, and ID4.px3 can be decoded in sequence according to the decoding order.

In the decoding process, if the newly added to-be-decoded point is exactly the same as the next to-be-decoded point of the current decoding point stored in the FIFO, the next to-be-decoded pixel point of the current decoding point stored in the FIFO can be read out from the FIFO and discarded.

Continuing with FIG. 4 as an illustration, for example, assuming that the current decoding point is ID3.px0, the context of ID3.px0 can be calculated and ID3.px0 can be decoded to obtain second importance information of ID3.px0. According to the second importance information of ID3.px0 and the first importance information within the reference range and the second importance information within the reference range, it can be predicted whether the group ID3 in which ID3.px0 is located and its right neighboring group ID4 have newly added to-be-decoded points in the s-channel. As shown in FIG. 4, assuming that the newly added to-be-decoded points in ID3 is ID4.px1, ID4.px2, and ID4.px3, the first to-be-decoded point in the s-channel, i.e., ID4.px1 can be found. ID4.px1 can be compared with the next to-be-decoded point of the current decoding point stored in FIFO. According to the prediction of the s-channel described above, the next to-be-decoded point of ID3.px0 stored in the FIFO can be ID6.px1, which can be different from the first newly added first to-be-decoded point ID4.px1. In the next clock cycle, newly added pixel point ID4.px1 may need to be decoded directly.

Another example is illustrated by using ID6.

Assuming that the current decoding point is ID6.px1, the context of ID6.px1 can be calculated and ID6.px1 can be decoded to obtain the second importance information of ID6.px1. According to the second importance information of ID6.px1 and the first importance information within the reference range and the second importance information within the reference range, it can be predicted whether the group ID6 in which ID6.px1 is located and its right neighboring group ID7 can have newly added to-be-decoded points in the s-channel. Assuming the predicted ID7.px1 needs to be decoded in the s-channel, it can be determined whether ID7.px1 and the next to-be-decoded point after the current decoding point ID6.px1 stored in the FIFO are the same. According to the above description it may be known that the next to-be-decoded point after ID6.px1 stored in the FIFO is different from ID8.px0. Therefore, ID7.px1 can be directly decoded in the next clock cycle.

ID7.px1 can be decoded to obtain the second importance information of ID7.px1. According to the second importance information of ID7.px1 and the first importance information and the existing second importance information within the reference range thereof, the to-be-decoded pixel points in the s-channel in the group ID7 in which ID7.px1 is located and its right adjacent group ID8 can be predicted.

It is assumed the predicted ID8.px0 needs to be decoded in the s-channel. ID8.px0 and the next to-be-decoded point stored in the FIFO can be compared, and it has been found that the newly added pixel point ID8.px0 can be the same as the next to-be-decoded point stored in the FIFO. Then, ID8.px0 can be read from the FIFO and discarded. In the next clock cycle, the newly added to-be-decoded point ID8.px0 can be directly decoded.

This process can be repeated until there is no new pixel point in the s-channel contained in the group where the current decoding point is located and the right adjacent group. Then, a new point to be decoded can be read from the FIFO to continue the decoding process.

For example, assuming that the current decoding point is ID4.px3, according to the second importance information of ID4.px3 and the first importance information and the existing second importance information within the reference range, it can be determined that the group ID4 in which ID4.px3 is located and the right adjacent group ID 5 contain no newly added point in the s-channel. Then, ID6.px1 can be read from the FIFO to continue the decoding process.

The above is an illustration of the prediction and reconstruction process for s-channels.

The prediction and reconstruction processes for m-channel and c-channel are described below.

### 2. Prediction and Reconstruction of M-Channel

(1) Prediction of M-Channel

In this application, the m-channel may employ first-stage prediction, second-stage prediction, or multi-stage prediction. Second-stage prediction is described below as an example.

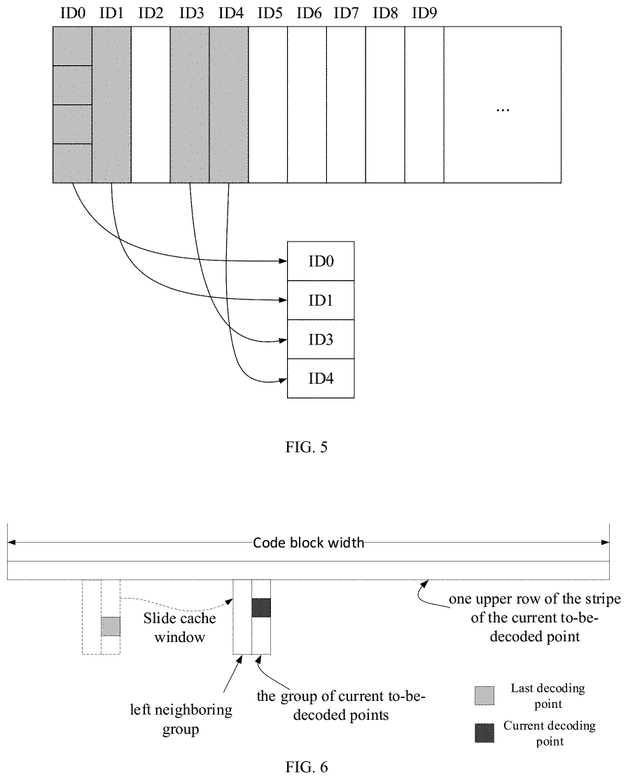

The process of the first-stage prediction is first illustrated in conjunction with FIG. 5. Referring to FIG. 5, FIG. 5 is a schematic diagram of a first-stage prediction process.

### First-Stage Prediction

Each stripe can be divided into a plurality of groups, wherein each group can contain at least one column of pixel positions. By using the first-stage prediction, the group in each stripe that do not contain the to-be-decoded points in the m-channel can be screened out, and only the group in each stripe that contains the to-be-decoded points in the m-channel can be kept. The number of groups containing the to-be-decoded points in the m-channel can be written into the first-stage FIFO.

For example, for a code block with a size of 32×32, the size of the stripe can be 32×4. In the first-stage prediction, each stripe can be divided into 32 groups according to 1×4, and the to-be-decoded points in the m-channel can be sequentially detected within each group from left to right. If a group contains the to-be-decoded points in the m-channel, then the number of this group and the to-be-decoded information for each pixel point in this group can be written into the first-stage FIFO. As shown in FIG. 5, through the first-stage prediction, the number of groups written in the first-stage FIFO can be ID0, ID1, ID3, and ID4, for instance. It should be noted that the gray group filled in FIG. 5 indicates that there is a point in the set that needs to be decoded in the m-channel.

### Second-Stage Prediction

The number of groups stored in the first-stage FIFO can be read, and the pixel points in each group that need to be decoded in the m-channel can be checked according to the number of groups. The location information of the point that needs to be decoded and other information needed for decoding can be written to the second-stage FIFO.

Here, the other information that may be needed for decoding can include the first importance information and the first sign mark for each point that needs to be decoded and its 8 neighborhood points.

It is understood that the first importance information and the first sign mark herein may refer to the importance information and the sign mark for each pixel point prior to the m-channel decoding, respectively.

Alternatively, within the first clock cycle, information of 1 to 4 points may be written to the second-stage FIFO. In other words, within the first clock cycle, the information of each point in the 1×4 group may be written to the second-stage FIFO.
(2) M-Channel Reconstruction

In the process of decoding reconstruction, the information of each to-be-decoded point can be read from the second-stage FIFO, and the context of each to-be-decoded point can be calculated according to the information of each to-be-decoded point, thereby reconstructing the COEF coefficients and/or SIGN signs for each point.

It is understood that according to the characteristics of the m-channel and the reconstruction process of the s-channel, unlike the reconstruction process of the s-channel, there may be no new to-be-decoded pixel points increased in the m-channel during the m-channel reconstruction process. Therefore, the pixel point in the m-channel may not generate the second importance information and the second sign mark. Thus, the reconstruction of the m-channel can be decoded according to the first importance information and the first sign mark of each to-be-decoded point and the 8 points of the neighborhood in the m-channel.

It should be noted that the m-channel may also employ multi-stage prediction, and the two-stage prediction in m-channels here is only as an example.

In the first-stage prediction of the two-stage prediction described above, it can be predicted that the pixel points that need to enter the m-channel for decoding can be predicted in 1×4 unit. If 1×4 is treated as a group, in one stripe, the first-stage prediction can be to determine whether there are to-be-decoded pixel points in each group in m-channels from left to right in groups.

Multi-stage prediction may be further achieved if a greater number of unit definitions of pixel points that need to enter the m-channel for decoding can be predicted from a stripe.

For example, using 4×Z as a first-stage group, it can be checked whether each group contains to-be-decoded pixel points, where Z>1, and Z is an integer. With code block size 32×32 as an example, 1<Z≤32. Assumes Z=4, then one stripe can be divided into 8 groups. The first-stage prediction can sequentially check the eight groups in one stripe from the left to the right that contains the to-be-decoded pixel points, and can write the number of the groups to the first-stage FIFO.

Assuming that the number of N first-stage groups is stored in the first-stage FIFO, where N≤8, and N is an integer. In the second-stage prediction, the numbers of the first-stage groups stored in the first-stage FIFO can be read, the first-stage groups can be divided into a plurality of second-stage groups in 4×L units, and whether the to-be-decoded pixel points in the m-channel are included in each second-stage group can be checked. 1<L<4, and L is an integer. Here, assuming L=2, the group stored in the first-stage FIFO can be checked in 4×L units to determine whether contains groups to-be-decoded in the m-channel, and the numbers of the second-stage group can be written into the second-stage FIFO.

In the third-stage prediction process, the numbers of the second-stage group stored in the second-stage FIFO can be read, and the numbers of pixel points s in each group can be checked in 4×Q units to determine whether contain to-be-decoded pixel points in the m-channel. 1≤Q<L, and Q is an integer. Here, assuming Q=1, the position of the to-be-decoded pixel points in each group stored in the second-stage FIFO can be checked in 4×1 units, and the position information of the to-be-decoded pixel points and other information that may be needed for decoding (e.g., neighborhood importance marks, sign marks, etc.) can be written into the third-stage FIFO.

It should be noted that the FIFO may be written only the position information of the to-be-decoded pixel points during the prediction of the s-channel, and the other information that may be needed for decoding can be read from the cache. This is because the importance information of the pixel points in the s-channel may change during the prediction process, and therefore, may only be able to read from the cache. However, in the prediction process of the m-channel and c-channel, it is contemplated that the resource consumption from the cache read information can be relatively large, and therefore, the m-channel and c-channel may store the information needed for decoding into the last-stage FIFO. When the m-channel and c-channel are reconstructed, the information needed for decoding can be read directly from the last-stage FIFO.

When the m-channel is decoded, the information of the to-be-decoded pixel points can be read from the last-stage FIFO, the context of each to-be-decoded pixel point can be calculated, and the COEF coefficients and/or the SIGN signs of each point can be reconstructed.

A person skilled in the art can reasonably infer the prediction process of other stages (e.g., 4th-stage or 5th-stage prediction) according to the description and example of the present application for multi-stage prediction, which shall fall within the scope of the present application. In addition, the size and morphology of the packets employed in the first-stage or multi-stage prediction process described in this application are by way of example only, and not for limiting the use of other sizes and forms of packets. For example, groups of pixels may take forms other than rectangular.
3. Prediction and Reconstruction of C-Channel

The c-channel may employ the same prediction process and reconstruction process as the m-channel, so a person skilled in the art may apply the prediction and reconstruction of the m-channel to the prediction and reconstruction of the c-channel.

Alternatively, the c-channel prediction process may also employ first-stage prediction, second-stage prediction, or multi-stage prediction, which is not limited in this application.

The prediction and decoding reconstruction of each channel in the bit plane decoding process is described in detail above.

In the bit-plane decoding method provided by the present application, by designing multi-stage prediction, the position where the decoding is not needed in the reconstruction process can be omitted. By employing the “prediction plus reconstruction” approach, a relatively large amount of idle time can be reduced in the reconstruction process, for instance, comparing to the “scan reconstruction” approach, and therefore the speed of bit plane decoding can be improved.

In addition, the area consumption caused by the parallelism of the bit plane decoder (BPD) can be reduced, and the decoding performance can be improved as a whole.

In the decoding reconstruction process of the s-channel and the c-channel of the bit-plane decoding, the importance information and/or sings (i.e., SIGN) of each pixel point may be updated with the decoding of the respective pixel points.

Using the s-channel as an example, the first importance information used in prediction can be the state of points before the s-channel decoding. In the process of actually decoding reconstruction in s-channel, some points that need to be decoded may be added. Therefore, the predicted to-be-decoded points and the actual to-be-decoded points in the reconstruction process may not be completely consistent. In other words, there may be some points predicted as no need to be decoded become the point that needs to be decoded. Thus, in the reconstruction process of the s-channel, the importance information and/or sign markers for each point can be updated.

As another example, in c-channel reconstruction, the update of the importance information and the marks of each point in the reconstruction process of the c-channel do not change the to-be-decoded point in the reconstruction process, i.e., the to-be-decoded point is not newly added in the reconstruction process, but the calculation form of the context of the to-be-decoded point in the reconstruction process can be changed. For example, whether run-length is used may be changed. Thus, if the importance information and marks are updated for some points, the calculated form of the context for each predicted to-be-decoded point may not be the calculation form that should be used in the actual reconstruction process.

Hence, the present application proposes designing two stages of importance information and sign marks for s-channel and c-channel.

The importance information and sign marks of the first stage can be the importance information and the sign marks of the s-channel or c-channel before reconstruction. The importance information and sign marks of the second stage can be the importance information and sign marks that are re-determined in the reconstruction process by the s-channel or the c-channel.

For convenience of description, the importance information of the first stage may be referred to herein as the first importance information, and the sign mark of the first stage may be referred to as the first sign mark. The importance information of the second stage may be referred to as the second importance information, and the sign mark of the second stage may be referred to as the second sign mark.

In the description of the prediction process for s-channel and c-channel, first importance information can be used in predicting the to-be-decoded point.

In the description of the s-channel and c-channel reconstruction processes above, the determination of the next to-be-decoded point of the current decoding point and the calculation of the context can be based on the results of the “OR” operation of the first importance information and the second importance information. If there is a need to calculate the sign context for some pixel points, the operation can also be based on the results of the “OR” operation of the first sign mark and the second sign mark.

Here, the result of a “OR” operation may also be referred to as a “real-time state.”

For different decoding channels, a determination condition for whether calculating a sign of a certain pixel point may be different. For example, in the s-channel or c-channel decoding process, if the importance information of a location is changed from 0 to 1, then the sign at this location can be decoded in the next step.

When the importance information of the second stage is cached, only the second importance information of the pixel points in the group that the current decoding point is located, adjacent to the left side, and of the upper row of the stripe in which the current decoding point is located, may be required to be cached. Thus, when the importance information of the second stage is cached, two columns of cache windows may be included. FIG. 6 is described below for details.

Referring to FIG. 6, FIG. 6 is a schematic diagram of a caching process for the importance information of the second stage. As shown in FIG. 6, in the reconstruction process of the s-channel and the c-channel, the predicted to-be-decoded point can be decoded while the second importance information of the current decoding point is updated according to the decoding result. If the next to-be-decoded point and the current decoding point are not within the same 1×4 set, then after completing the decoding of the current decoding point, the cache window can be slid to next to-be-decoded point.

Each time when the cache window is slid, the second importance information of pixel points in the last row of the two 1×4 sets within the cache window may need to be transferred to the cache located in the one upper row of the current stripe in the same column.

When the second sign mark is cached, only the sign marks of the pixel points located in the group of current to-be-decoded points, the left neighboring group, and the group on one upper row of the stripe of the current to-be-decoded point, may be required to be cached.

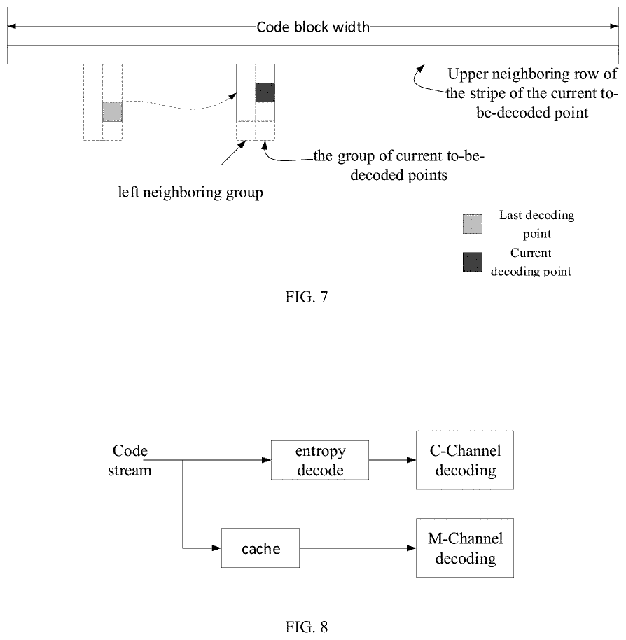

The caching process is described below in conjunction with FIG. 7.

Referring to FIG. 7, FIG. 7 is a schematic diagram of a cache process for sign mark of a second stage. As shown in FIG. 7, in the reconstruction process of the s-channel and the c-channel, when decoding the predicted to-be-decoded point, the sign mark of the second stage of the current decoding point can be updated according to the decoding result. If the current decoding point is the last point in the group, the decoded sign mark can be directly updated to the corresponding position of the one upper row of the stripe where the current decoding point is located. If the next decoding point and the current decoding point are not within the same group, after completing the decoding of the current decoding point, the cache window may need to be slid to the next to-be-decoded point.

Alternatively, the sign mark of the second stage may also be referred to herein as a second sign mark.

Based on the two-stage design of the importance information and the sign mark proposed in the present application, the decoding point of run-length operation can be predicted in the prediction process of the c-channel. In the decoding reconstruction process of the c-channel, the “real-time state” can be used to determine whether the decoding points need to adopt the run-length decoding operation. After predicting the point that needs to be decoded in the prediction process of the s-channel, it may also be inferred from the “real-time state” whether there are other to-be-decoded points in the current 1×4 pixel group and the right neighboring 1×4 pixel group.

According to the technical scheme of the present application, the importance information and the sign mark may be changed in the decoding and reconstruction process, so that the mark information used during prediction and the mark information used during reconstruction can be designed as two stages. The marked information layer (i.e., the second stage) that changes in the reconstruction may only need to store a smaller range portion. In this way, the prediction can be run ahead of time before reconstruction, and the to-be-decoded position and the context can be relatively quickly corrected by utilizing the mark information of the second stage in the reconstruction. So that not only the contradiction between the advance prediction and the state update can be solved, the negative influence on the increase area and the timing sequence can also be reduced to the lowest to improve the bit plane decoding speed and the decoding performance.

In addition, in the decoding reconstruction of each channel, the calculation of the context of the decoding point can also calculated based on the “real-time state.”

Furthermore, in view of the balance of decoding speed and compression, in an embodiment of the present application, the rest of the bit planes except the first 4 non-zero planes can be decoded using the lazy mode.

In decoding using the lazy mode, the m-channel may not entropy decode, but rather can directly read the code stream as a result of the decoding of the various points.

Alternatively, in embodiments of the present application, the m-channel and the c-channel can be decoded in parallel.

Specifically, after completing the decoding reconstruction of the s-channel, the code stream of the m-channel can be received from the code inflow port. The received m-channel code stream can be stored in a cache after the past fill process, for example, into a memory buffer. The decoding of the m-channel can then be performed from the read-out code stream in the storage buffer. When decoding the m-channel, a new code stream may be read for decoding of the c-channel.

Referring to FIG. 8, FIG. 8 is a diagram illustrating the m-channel decoding using the lazy mode. As shown in FIG. 8, from the timing, the code stream of the m-channel can be buffered first and then the m-channel begins to decode. After the m-channel is decoded for a certain time, the c-channel can begin to decode. The buffering of the m-channel and the decoding of the c-channel may be performed at the same time, or the decoding of the m-channel may also be initiated after the full cache of the m-channel is complete.

Referring to FIG. 9, FIG. 9 is a schematic diagram of m-channel and c-channel parallel decoding. In FIG. 9, the m-channel can be decoded for a period of time after the start of the code stream buffer of the m-channel, and the c-channel can start to decode through a staggered window.

Here, the c-channel can start decoding a staggered window later than the m-channel, since the c-channel may determine which locations need to be decoded only after the m-channel updates the decoded mark.

The staggered window can be at least one clock cycle. Alternatively, the staggered window may be a stripe, which may help control decoding.

It should be noted that the buffering of the m-channel and the time at which the m-channel begins to decode may not be any limitation, for instance, as long as the speed of the cache of the m-channel is greater than the speed employed by the m-channel decoding. However, it is contemplated that a dual-port random access memory (RAM) capable of both reading and writing may be implemented if the speed of the cache and the speed of the decoding are not limited. As such, the area of the RAM may be particularly large. Thus, the single-port RAM may be selected by limiting the decoding of the code stream of the m-channel after the full cache is completed, which can reduce the area and power consumption of the RAM.

In addition, in order to increase the decoding speed, considering the importance information obtained by decoding of the m-channel may not affect the decoding of the other to-be-decoded points, the m-channel may employ a parallel decoding scheme. In the lazy mode, the m-channel may decode multiple pixel points in one clock cycle.

As one example, the decoder can decode a 4×N rectangular region within one clock cycle. In other words, N=4, and 16 pixel points can be decoded within one clock cycle.

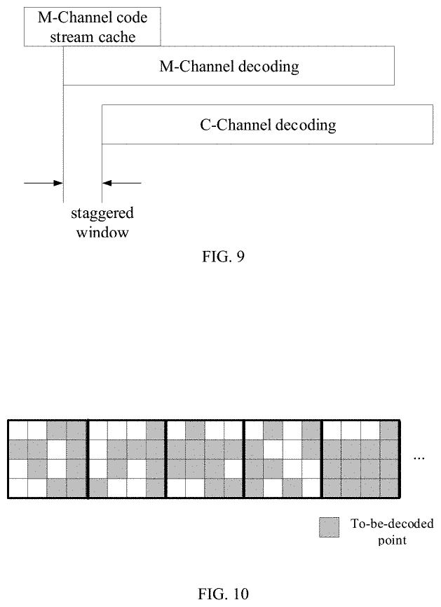

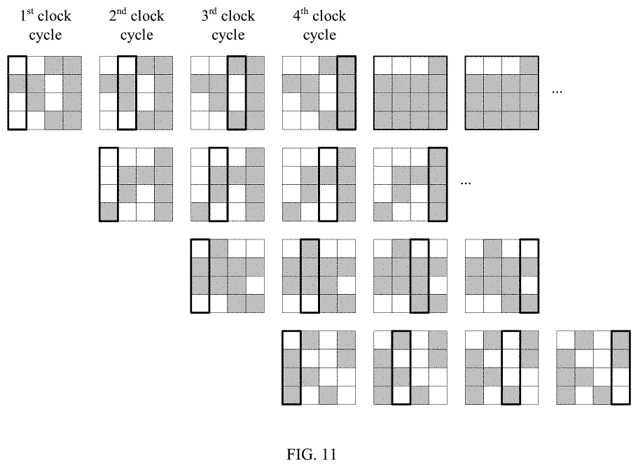

As shown in FIG. 10, FIG. 10 is a diagram illustrating four pixel points decoding within a clock cycle.

For a 4×4 region, it can be first predicted how many to-be-decoded pixel points in the m-channel are in this region (e.g., nine to-be-decoded points are included in the first 4×4 region shown in FIG. 10). Then, a corresponding number of code streams can be read from the code stream (e.g., 9 bit code streams need to be read in the case shown in FIG. 10). Subsequently, according to the order from left to right, a 1×4 pixel group can be reconstructed in each clock cycle, and 16 pixel points can be reconstructed in four clock cycles.

FIG. 11 is a schematic diagram of a parallel decoding process. The decoding of 16 pixel points may be completed within the 4th clock cycle and every subsequent clock cycle.

The above is an illustration of the bit plane decoding process provided by the present application. After decoding the bit plane to obtain the transform coefficients (i.e., COEF coefficients), an inverse transform may be performed next according to the introduction of the bit plane decoding process in FIG. 1.

To improve the quality of the reconstructed image (e.g., signal-to-noise ratio), optionally, the transform coefficients can be corrected prior to performing inverse transformation of the transform coefficients.

In a hardware implementation, the operation of correcting the COEF coefficients can be performed when the COEF coefficients are uniformly output from the decoder to the inverse transform module.

Specifically, if the transform coefficient corresponding to one pixel point is non-zero, a correction value can be added to the last bit plane of the last decoded bit plane of the entire code block to correct the transform coefficients. The specific values of the correction values are not limited in this application.

For example, 1 can be incremented on the last bit plane of the last decoded bit plane as a correction value. Also for example, 1 can be added as a correction value on the last two bit planes of the last decoded bit plane, respectively.

Those skilled in the art will appreciate that the correction value “1” herein can refer to a binary. Thus, if 1 is added on the last bit plane of the last decoded bit plane, the transform coefficient can be added 0.5 in decimal. If 1 is added on the last two bit planes of the last decoded bit plane, the transform coefficients can be added 0.75 in decimal.

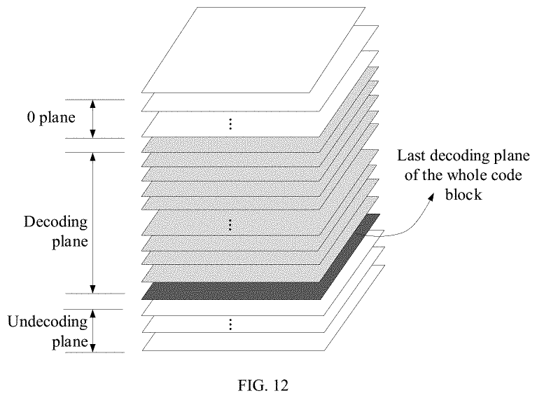

The correction process is described below in conjunction with FIGS. 12-15.

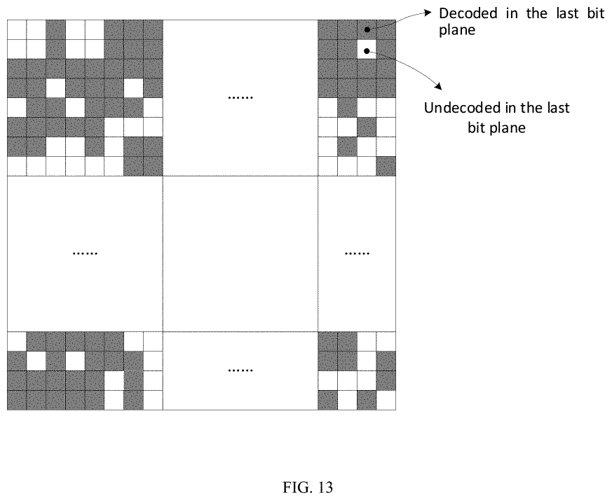

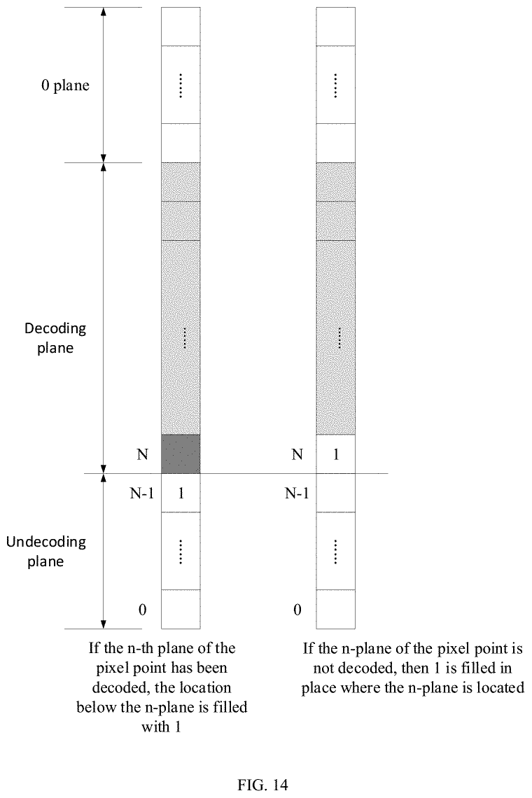

Referring to FIG. 12, FIG. 12 is a schematic diagram of a decoding plane and a non-decoding plane after a code block is decomposed into a bit plane. When the decoder completes the decoding of all bit planes of one code block, the reference number of the current bit plane can be recorded and the point at which the current bit plane is decoded can be saved. Referring to FIG. 13, FIG. 13 is a schematic diagram of marking the decoded and undecoded pixel points in a code block.

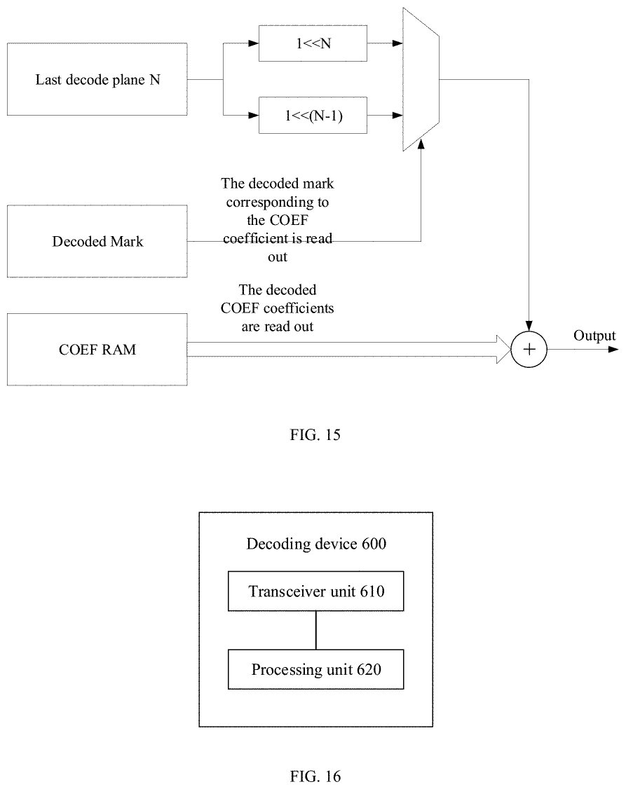

When the decoder outputs a COEF coefficient, for each COEF coefficient, if its value is not equal to 0, the correction value can be added to which bit of the COEF coefficient is determined according to the reference number of the last decoded bit plane and whether this pixel point is decoded in the bit plane of this COEF coefficient. The process of adding the correction value is shown in FIG. 14, which is a schematic diagram of the COEF coefficient adding correction value. The process of determining which bit to add a correction value at the COEF coefficient is shown in FIG. 15, which is a process schematic of adding a correction value to the COEF coefficient.

It should be noted that the last bit plane may not be necessarily to perform decoding on all three channels and may only one or two channels be decoded. In this case, only partial points may be decoded. For these partial points, the current bit plane can be the last decoded plane, while the remaining points may not be decoded on this bit plane. Thus, for these “remaining points,” the last decoding plane may actually be the last bit plane of this bit plane.

Comparing to the conventional methods adding the correction value during the decoding process, the times of writing RAM in the present application can be reduced, thereby reducing the power consumption and not occupying the decoding time. Thus, a high-speed decoding performance can be maintained.

The decoding apparatus provided in the present application is described below.

Referring to FIG. 16, FIG. 16 is a schematic block diagram of a decoding device 600 according to embodiments of the present application. As shown in FIG. 16, the decoding device 600 can include a transceiver unit 610 and a processing unit 620, wherein the transceiver unit 610 can acquire a code block to be decoded. The processing unit 620 can perform bit plane decoding on the to-be-decoded code block acquired by the transceiver unit 610 using the bit plane decoding method provided by the present application.

Alternatively, the transceiver unit 610 may be a transceiver, or a communication interface. The communication interface may include an input/output interface, a pin, or an interface circuit. Optionally, the interface circuit may include a receive circuit and an output circuit.

Alternatively, the transceiver unit 610 may also be replaced by a receiving unit and/or a transmitting unit.

For example, the transceiver unit 610 may be replaced by a receiving unit when performing the received step. The transceiver unit 610 may be replaced by a transmitting unit when performing the step of sending or outputting.

Optionally, the decoding device 600 may also include a storage unit 630 to store computer programs or data. The processing unit 620 may invoke computer programs or data in the storage unit 630 such that the decoding device 600 implements the corresponding functions or steps. The storage unit may be referred to or characterized as memory, particularly non-transitory computer-readable memory.

Alternatively, the processing unit 620 may be a processor (including one or more processors), a logic circuit, an integrated circuit, or the like. The storage unit 630 may be a memory.

The units and other operations or functions in the decoding device 600 of the embodiments of the present application can be respective operations and/or processes for implementing the bit plane decoding of the present application, respectively. For example, the transceiver unit 610 can obtain a to-be-decoded code stream, the processing unit 620 can perform prediction, reconstruction (i.e., decoding) in the bit plane decoding process, and can perform processing or operation on the COEF coefficients, etc., and the storage unit 630 can cache sign marks and importance information (e.g., second importance information and second sign mark), etc. For the sake of brevity, detailed description is omitted here.

In one implementation, the above-described functionality of the decoding device 600 may be implemented in part or in whole by software. When implemented in whole by software, the decoding device 600 may include a memory and a processor (including one or more processors). The memory, which can be non-transitory computer-readable memory, can be used to store a computer program, and the processor can read and run the computer program from the memory so as to execute the bit plane encoding method in the method embodiment.

In another implementation, the decoding device 600 can include only a processor when some or all of the decoding device 600 is implemented by software. A memory to store a computer program (including one or more computer programs), which can be non-transitory computer-readable memory, can be located outside of the decoding device 600, which can be connected to the memory through a circuit/wire for reading and executing the computer program stored in the memory.

In another implementation, when some or all of the above-described functions of the decoding device 600 are implemented in hardware, the decoding device 600 can include an input interface circuit to acquire wavelet coefficients, a logic circuit to perform bit plane decoding on the wavelet coefficients according to a bit plane encoding method in an embodiment of the present application to obtain COEF coefficients, and an output interface circuit to output the COEF coefficients.

Optionally, the logic circuit can correct the COEF coefficients before outputting the COEF coefficients and output the corrected COEF coefficients.

Alternatively, the decoding device 600 may be a chip or an integrated circuit.

Alternatively, the decoding device 600 may be a decoder.

Optionally, the decoding device 600 may also be a communication device equipped with a decoder, wherein the decoder installed on the communication device can perform bit plane decoding using the bit plane decoding method provided by the present application.

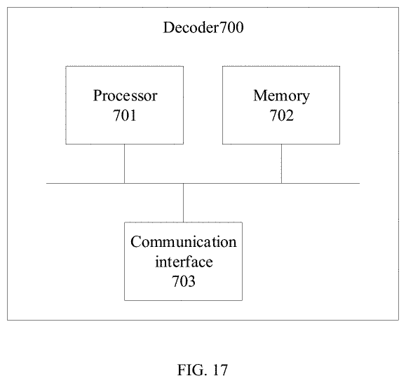

FIG. 17 is a schematic structural diagram of a decoder 700 provided according to embodiments of the present application. As shown in FIG. 17, the decoder 700 can include one or more processors 701, one or more memories 702, and one or more communication interfaces 703. The communication interface 703 can be used to obtain a to-be-decoded code stream, the memory 702 can be used to store a computer program, and the processor 701 can be used to invoke and execute a computer program stored in the memory 702 such that the decoder 700 performs the bit plane decoding method of the embodiments of the present application.

Further, the communication interface 703 can also be used to output the decoded COEF coefficients.

Alternatively, the communication interface receiving the to-be-decoded code stream may be different or the same as the communication interface for outputting the decoding result.

Alternatively, the memory 702 and the processor 701 may be integrated together or physically separate units.

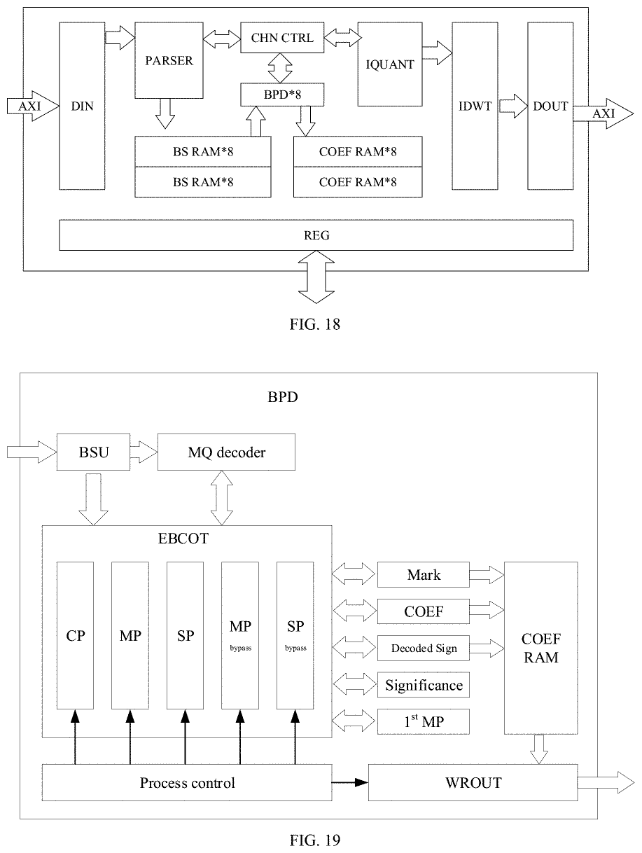

An example of a hardware structure that may be used to perform the bit plane decoding method provided by the present application is given below in connection with FIG. 18.

Referring to FIG. 18, FIG. 18 is a block diagram of a decoder according to the present disclosure.

As shown in FIG. 18, a Data In (DIN) module can read the code stream data of an to-be-decoded image from a Double Data Rate RAM (DDR) through an Advanced Extensible Interface (AXI). Parsing Module (Parser) can parse the header of the code stream read in the DIN module, and the code stream can be partitioned into burst pipeline synchronous static random access memory (BS RAM) according to the code block. For example, FIG. 18 shows the BS RAM*8, the bit plane decoder (BPD) can employ 8-way parallel decoding, and the BPD can store the decoded COEF to the COEF RAM (e.g., COEF RAM*8 shown in FIG. 18). Channel control (CHN Ctrl) can be responsible for the organization and scheduling of 8-way parallel BPD.

The inverse quantization (IQUANT) module can be used for inverse quantization and outputs the quantized result to an inverse discrete wavelet transform (DWT) module. The data after the inverse wavelet transform of the DWT module can be output to a data out (DOUT) module and output to the DDR via AXI.

In FIG. 18, BS RAM*8, COEF RAM*8, and BPD*8 may each represent 8-way parallel. Of course, the 8-way parallel is by way of example only, and is not limited herein.

In addition, the REG shown in FIG. 18 can represent a register interface, i.e., a register configuration interface, for providing configuration information for other modules.

Referring to FIG. 19, FIG. 19 is a schematic diagram of an internal structure of a BPD. The code stream processing unit (BSU) shown in FIG. 19 can be responsible for the reading of the code stream, the allocation of the decoding channel, the caching, and the shifting. MQ Decoder can be an arithmetic decoding (i.e., entropy decoding) unit. A process control unit can be responsible for the control of the decoding flow. A write out module (WROUT) can be used for result output control.

The BSU can read the code stream from the BS RAM of the corresponding code block (CB). EBCOT can calculate the context. At the same time, the BSU can send the code stream to the MQD for entropy decoding, and the decoded bit value can return to the EBCOT for COEF reconstruction. The reconstructed COEF and sign mark can be written to the COEF RAM.

The CP shown in FIG. 19 can represent a c-channel. MP may be simply referred to as MRP, and MRP can represent a m-channel. The SP can represent the s-channel. The MP bypass mode can indicate that the MP employs the lazy mode. The SP bypass mode can indicate that the SP employs the lazy mode.

In addition, SIGN in FIG. 19 can represent sign mark, the DECODED FLAG can represent the decoded flag, the first MP can represent the first MRP, and SIGNIFICANT can represent the significant information.

Furthermore, the present application can also provide a computer-readable storage medium having stored thereon a computer program (or as a computer instruction) that, when executed on a computer, causes a computer to perform a method of bit plane decoding in an embodiment of the present application. The computer-readable storage medium can be non-transitory.

The present application can also provide a computer program product having computer program code that, when executed on a computer, causes a computer to perform a method of bit plane decoding in an embodiment of the present application. The computer program product can be implemented in or using non-transitory computer-readable storage.

The present application may also provide a chip including a processor. The memory to store a computer program can be provided independent of the chip, and the processor can be configured to execute a computer program stored in the memory to perform the bit plane decoding method in an embodiment of the present application.

Optionally, the chip also includes the memory.

Further optionally, the chip also includes a communication interface. The communication interface may be a transceiver, an input/output interface, a pin or circuit, or the like.

Alternatively, the processor described above may be one or more, and the memory may be one or more.

Alternatively, the memory may be integrated with the processor, or the memory may be separate from the processor.

Alternatively, the processor may be a logic circuit, an integrated circuit, or the like.

In various embodiments, the processor may be a central processing unit (CPU), a general-purpose processor, a digital signal processor (DSP), an application specific integrated circuit (ASIC), a field programmable gate array (FPGA) or other programmable logic device, discrete gate or transistor logic, discrete hardware component, microprocessor, or one or more integrated circuits for controlling the execution of a program of the present application. For example, the processor may include a digital signal processor device, a microprocessor device, an analog-to-digital converter, a digital-to-analog converter, or the like. The processor may allocate functions of controlling and signal processing of the mobile device among these devices according to their respective functions. Further, the processor may include functionality to operate one or more software programs, which may be stored in memory. The functions of the processor may be implemented by hardware or by hardware executing corresponding software implementations. The hardware or software includes one or more units corresponding to the functions described above.

The memory may be read-only memory (ROM) or other type of static storage device that may store static information and instructions, random access memory (RAM), or other types of dynamic storage devices that may store information and instructions. The memory may be an electrically erasable programmable read-only memory (EEPROM), compact disc read-only memory (CD-ROM) or other optical disk storage, optical disk storage (including compact disc, laser disc, optical disc, digital versatile disc, Blu-ray disc, etc.), magnetic disk storage media or other magnetic storage devices, or any other medium that can be used to carry or store desired program code in the form of instructions or data structures and that can be accessed by a computer, but is not limited thereto. As noted above, the memory may be non-transitory.

In the embodiments described above, it may be implemented in whole or in part by software, hardware, firmware, or any other combination. When implemented by software, it may be implemented in whole or in part in the form of a computer program product. The computer program product includes one or more computer instructions. When the computer program instructions are loaded and executed on a computer, the processes or functions described in accordance with embodiments of the present disclosure are generated in whole or in part. The computer may be a general purpose computer, a special purpose computer, a computer network, or other programmable apparatus. The computer instructions may be stored in a computer-readable storage medium or transmitted from one computer-readable storage medium to another computer-readable storage medium, e.g., the computer instructions may be transmitted from one website site, computer, server, or data center over a wired (e.g., coaxial cable, optical fiber, digital subscriber line (DSL)), or wireless (e.g., infrared, wireless, microwave, etc.) to another website site, computer, server, or data center. The computer-readable storage medium may be any available media that can be accessed by a computer or a data storage device that includes one or more available media integrated servers, data centers, and the like. The available media may be magnetic media (e.g., floppy disk, hard disk, magnetic tape), optical media (e.g., digital video disc (DVD)), or semiconductor media (e.g., solid state disk (SSD)), and the like.

Those of ordinary skill in the art will recognize that the elements and algorithm steps of the examples described in connection with the embodiments disclosed herein can be implemented in electronic hardware, or a combination of computer software and electronic hardware. Whether such functionality is implemented in hardware or software depends upon the particular application and design constraints of the technical solutions. Those of ordinary skill in the art may implement the described functionality using different methods for each particular application, but such implementation should be considered within the scope of the present application.

In several embodiments provided herein, it is understood that the disclosed systems, apparatuses, and methods may be implemented in other ways. For example, the apparatus embodiments described above are merely illustrative, for example, division of the units, only one logical function partition, an actual implementation may have additional partitioning modes, such as multiple units or components may be combined or may be integrated into another system, or some features may be omitted, or not performed. Alternatively, the coupling or direct coupling or communication connection between each other shown or discussed may be an indirect coupling or communication connection through some interfaces, devices, or units, which may be in electrical, mechanical, or other forms.

The units described as separate components may or may not be physically separate, the components shown as units may or may not be physical units, i.e., may be located in one place, or may be distributed over multiple network elements. Some or all of the elements therein may be selected according to actual needs to achieve the objectives of the technical solutions of the present embodiment. Moreover, some or all of the units may be implemented in or using one or more processors or processing circuitry.

In addition, the functional units in various embodiments of the present application may be integrated in one processing unit, or may be separately physically present in each unit, or may be integrated in one unit by two or more units.

Those skilled in the art will readily observe that numerous modifications and alterations of the device and method may be made without departing from the spirit and scope of the application as defined by the appended claims. Accordingly, the scope of the appended claims should be accorded the broadest interpretation so as to encompass all such modifications and similar arrangements.

It should be noted that relational terms, such as first and second, etc., are used herein to distinguish one entity or operation from another entity or operation without necessarily requiring or implying any such actual relationship or order between such entities or operations. The terms “comprises,” “comprising,” or any other variation thereof, are intended to cover a non-exclusive inclusion, such that a process, method, article, or apparatus that comprises a series of elements not only includes those elements but also includes other elements not expressly listed, or that is an element inherent to such process, method, article, or apparatus. In the absence of more constraints, elements defined by the term “comprises a . . . ” do not preclude the presence of additional similar elements in the process, method, article, or apparatus that includes the element.

The present disclosure has been described in detail with reference to the principles and implementations of the present disclosure. The foregoing description of the embodiments has been presented only to aid in the understanding of the methods of the present disclosure and its core idea. For a person of ordinary skill in the art, in accordance with the concepts of the present disclosure, it is not to be understood that the present specification is not to be construed as a limitation on the present disclosure.

What is claimed is:

1. A bit plane decoding method, comprising:
obtaining, using a processor, a code block to be decoded, the code block comprising a plurality of stripes, each said stripe including a plurality of pixel positions to be decoded;
performing, using the processor, an L-stage prediction on the plurality of pixel positions included in each said stripe to divide the plurality of pixel positions in each said stripe into a corresponding decoding channel, the decoding channel comprising an s-channel, an m-channel, or a c-channel, wherein L is an integer greater than or equal to 1; and
decoding, using the processor, the pixel positions of each decoding channel to obtain wavelet coefficients for each pixel location.

2. The method of claim 1, wherein L≥3, and said performing the L-stage prediction on the plurality of pixel positions included in each stripe, further comprises:
dividing the plurality of pixel positions in each said stripe into Z j-th stage pixel groups, and performing j-th stage prediction on the Z j-th stage pixel groups to determine N j-th stage pixel groups from the Z j-th stage pixel groups, wherein each of the N j-th stage pixel groups comprises pixel positions to be decoded at the corresponding decoding channel, 1≤j≤L1, N<Z, and j, Z, and N are positive integers; and
dividing the N j-th stage pixel groups into M j+1-th stage pixel groups, and performing a j+1-th stage prediction on the M j+1-th stage pixel groups to determine Q j+1-th stage pixel groups from the M j+1-th stage pixel groups, wherein each of the Q j+1-th stage pixel groups comprises pixel positions to be decoded at the corresponding decoding channel, the j+1-th stage pixel group has a size smaller than the size of the j-th stage pixel group, Q<M, and Q and M are positive integers.

3. The method of claim 2, wherein j+1=L−1, and said performing the L-stage prediction on the plurality of pixel positions included in each said stripe to divide the plurality of pixel positions in each said stripe into the corresponding decoding channel, further comprises:
dividing the Q j+1-th stage pixel groups into P L-th stage pixel groups, each L-th stage pixel group comprising a column of pixel positions, P≥1, and P is an integer; and
performing an L-th stage prediction on the P L-th stage pixel groups to determine partial or all pixel positions in each L-th stage pixel group that need to be decoded at the corresponding decoding channel.

4. The method according to claim 1, wherein L=1, and said performing the first-stage prediction on the plurality of pixel positions included in each said stripe to divide the plurality of pixel positions in each said stripe into the corresponding decoding channel, further comprises:
dividing the plurality of pixel positions included in each said stripe into M pixel groups, each pixel group of the M pixel groups comprising a column of pixel positions, and M being a positive integer; and
performing a prediction on each pixel group of the M pixel groups to determine partial or all of the pixel positions in each pixel group that need to be decoded at the corresponding decoding channel.

5. The method of claim 1, wherein L=2, and said performing the L-stage prediction on the plurality of pixel positions included in each said stripe to divide the plurality of pixel positions in each said stripe into the corresponding decoding channel, further comprises:
dividing the plurality of pixel positions included in each said stripe into G first-stage pixel groups, and predicting the G first-stage pixel groups to determine K first-stage pixel groups from the G first-stage pixel groups, each pixel group of the K first-stage pixel groups comprising pixel positions to be decoded at the corresponding decoding channel, wherein each first-stage pixel groups comprises at least one column of pixel locations, G≥2, K<G, and G and K are both integers; and
performing a prediction on each pixel group of the K first-stage pixel groups to determine partial or all of the pixel positions from the K first-stage pixel groups that need to be decoded at the corresponding decoding channel.

6. The method of claim 4, wherein the decoding channel is the s-channel, and said performing the prediction on each pixel group of the M pixel groups to determine partial or all of the pixel positions in each pixel group that need to be decoded at the corresponding decoding channel, further comprises:
performing the prediction on each pixel group of the M pixel groups to determine a first pixel group and/or at least one second pixel group in the M pixel groups, wherein the first pixel group is a pixel group in the M pixel groups that first contains pixel positions that need to be decoded in the s-channel, and the second pixel group comprises pixel groups having pixel positions that need to be decoded in the s-channel to the right of the first pixel group and pixel groups excluding pixel positions that need be decoded in the s-channel to the left of the first pixel group;
wherein, the method further comprises:
when one of the first pixel groups and one or more second pixel groups are determined from the M pixel groups, or one of the first pixel groups is determined from the M pixel groups, a first to-be-decoded pixel position in the first pixel group and/or the one or more second pixel groups is sequentially written into a memory according to a decoding order;
wherein, said decoding the pixel positions of each decoding channel, further comprises:
reading a first pixel position stored in the memory and decoding the first pixel position to obtain a decoding result of the first pixel position;
based on the decoding result of the first pixel position, determining whether a new pixel position is generated that needs to be decoded in the s-channel in the pixel groups where the first pixel position is located and the right adjacent pixel group;
when the new pixel position is generated, determining and decoding a first new pixel position according to the decoding order; and
when no new pixel position is generated, reading and decoding a next pixel position from the memory.

7. The method of claim 6, wherein when the new pixel position is generated, said determining and decoding the first new pixel position according to the decoding order, further comprises:
determining whether the first new pixel location and the next pixel location after the first pixel location stored in the memory are the same and deciding whether the next pixel location stored in the memory needs to be read and discarded from the memory according to a determination result.

8. The method of claim 7, wherein said deciding whether the next pixel location stored in the memory needs to be read and discarded from the memory according to the determination result, further comprises:
when the first new pixel location and the next pixel location after the first pixel location stored in the memory are the same, reading and discarding the next pixel location stored in the memory; or
when the first new pixel location and the next pixel location after the first pixel location stored in the memory are different, after the decoding of the first new pixel position is completed, continuing to determine whether another new pixel position is generated that needs to be decoded in the s-channel in the pixel groups where the first mew pixel position is located and the right adjacent pixel group.

9. The method of claim 8, further comprising:
decoding a i-th pixel position that needs to be decoded at the s-channel to obtain a decoding result, wherein the i-th pixel position is a predicted or newly added pixel position that needs to be decoded in the s-channel;
based on the decoding result of the i-th pixel position, determining whether the new pixel position that needs to be decoded in the s-channel is generated in the pixel group where the i-th pixel position is located and the right adjacent pixel group;
when the new pixel position is generated, determining whether the first new pixel location relative to the i-th pixel position and the next pixel location relative to the i-th pixel position stored in the memory are the same according to the decoding order;
when the first new pixel location relative to the i-th pixel position and the next pixel location relative to the i-th pixel position stored in the memory are the same, discarding the next pixel location relative to the i-th pixel position stored in the memory and decoding the first new pixel location relative to the i-th pixel position; and
when the first new pixel location relative to the i-th pixel position and the next pixel location relative to the i-th pixel position stored in the memory are different, decoding the first new pixel location relative to the i-th pixel position.

10. The method of claim 9, wherein when the new pixel position that needs to be decoded in the s-channel is not generated in the pixel group where the i-th pixel position is located and the right adjacent pixel group, reading and decoding the new pixel position from the memory.

11. The method of claim 5, wherein the decoding channel is an m-channel, and after determining K first-stage pixel groups from the G first-stage pixel groups, the method further comprising:
writing a group number of each first-stage pixel group in the K first-stage pixel groups and a to-be-decoded mark of each pixel position into a first-stage memory according to the decoding order, wherein the to-be-decoded mark of each pixel position is used to indicate whether the pixel position needs to be decoded in the m-channel;
wherein, said performing the prediction on each pixel group of the K first-stage pixel groups to determine partial or all of the pixel positions from the K first-stage pixel groups that need to be decoded at the corresponding decoding channel, further comprises:
reading the group number of the K first-stage pixel groups stored in the first-stage memory, and according to the order of the group coding of the K first-stage pixel groups, predicting pixel positions in the K first-stage pixel groups that need to be decoded in the m-channel, and writing the predicted position information and the information needed for decoding in the m-channel into a second-stage memory, wherein the information needed for decoding comprises a first importance information and a first sign mark of the pixel positions that are written to the second-stage memory and the pixel positions within a reference range thereof;
wherein, said decoding the pixel positions of each decoding channel, further comprises:
sequentially reading the pixel positions in the second-stage memory that need to be decoded in the m-channel, and decoding each pixel position read according to the information needed for decoding the pixel position and all pixel positions within a reference range of the m-channel to obtain the wavelet coefficient of each pixel position of the m-channel.

12. The method of claim 5, wherein the decoding channel is a c-channel, and after determining K first-stage pixel groups from the G first-stage pixel groups, the method further comprising:
writing a group number of each first-stage pixel group in the K first-stage pixel groups and a to-be-decoded mark of each pixel position into a first-stage memory according to a decoding order, wherein the to-be-decoded mark of each pixel position is used for indicating whether the pixel position needs to be decoded in the c-channel;
wherein, said performing the prediction on each pixel group of the K first-stage pixel groups to determine partial or all of the pixel positions from the K first-stage pixel groups that need to be decoded at the corresponding decoding channel, further comprises:
reading the group number of the K first-stage pixel groups stored in the first-stage memory, and according to the order of the group coding of the K first-stage pixel groups, predicting pixel positions in the K first-stage pixel groups that need to be decoded in the c-channel, and writing the predicted position information and the information needed for decoding in the c-channel into a second-stage memory, wherein the information needed for decoding comprises a first importance information and a first sign mark of the pixel positions that are written to the second-stage memory and the pixel positions within a reference range thereof;
wherein, said decoding the pixel positions of each decoding channel, further comprises:
sequentially reading the pixel positions in the second-stage memory that need to be decoded in the c-channel, and decoding each pixel position read according to the information needed for decoding the pixel position and all pixel positions within a reference range of the c-channel to obtain the wavelet coefficient of each pixel position of the m-channel.

13. The method of claim 9, wherein based on the decoding result of the i-th pixel position, said determining whether the new pixel position that needs to be decoded in the s-channel is generated in the pixel group where the i-th pixel position is located and the right adjacent pixel group, further comprises:
determining a second importance information of the i-th pixel position according to a decoding result of the i-th pixel position; and
according to the second importance information of the i-th pixel position and the first importance information of the pixel positions within the reference range of the i-th pixel position, determining whether the new pixel position that needs to be decoded in the s-channel is generated in the pixel group where the i-th pixel position is located and the right adjacent pixel group.

14. The method of claim 13, further comprising:
decoding the i-th new pixel position that needs to be decoded in the s-channel according to the decoding order to obtain the decoding result, and determining, according to the decoding result, the second importance information of the i-th new pixel position that needs to be decoded in the s-channel, i≥1, and i being less than a sum of the number of pixel positions included in the two pixel groups; and
according to the second importance information of the i-th pixel position and the first importance information of the pixel positions within the reference range of the i-th pixel position, predicting whether the i-th new pixel group that needs to be decoded in the s-channel is generated in the pixel group where the i-th pixel position is located and the right adjacent pixel group.

15. The method of claim 1, wherein when the decoding channel is a s-channel or a c-channel, the method further comprises:
obtaining a second importance information and a second sign mark of the k-th pixel position according to a decoding result of the k-th pixel position that needs to be decoded in the s-channel or the c-channel; and
when the context of the k-th pixel position needs to be calculated according to the sign mark of the k-th pixel position of the s-channel or the c-channel, the context of the k-th pixel position is calculated according to the first sign mark and the second sign mark of the k-th pixel position, and the k-th pixel position is any one of the pixel positions that needs to be decoded in the s-channel or the c-channel.

16. The method of claim 15, wherein after said obtaining the second importance information and the second sign mark of the k-th pixel position according to the decoding result of the k-th pixel position, further comprises:
caching the second importance information and the second sign mark of the k-th pixel position by a cache window, wherein a size of the cache window comprises the pixel group where k-th pixel position is located and the left adjacent pixel group.

17. The method of claim 1, wherein said decoding the pixel positions of each decoding channel, further comprises:
acquiring a code stream of the m-channel, and storing the code stream of the m-channel into a cache; and
after a first time window, reading the code stream of the m-channel from the cache and decoding the code stream of the m-channel, wherein the length of the first time window is greater than 0.

18. The method of claim 17, wherein said decoding the pixel positions of each decoding channel, further comprises:
after decoding the code stream of the m-channel, obtaining the code stream of the c-channel after a second time window, entropy decoding the code stream of the c-channel, and decoding the code stream after entropy decoding, wherein the length of the second time window is greater than 0.

19. The method of claim 1, wherein after said obtaining wavelet coefficients for each pixel location, the method further comprises:
determining a non-zero wavelet coefficient;
adding a correction value to the non-zero wavelet coefficient to correct the non-zero wavelet coefficient; and
inverse transforming the wavelet coefficients.

20. The method of claim 19, wherein said adding the correction value to the non-zero wavelet coefficient, further comprises:
adding the correction value on a bit plane after a last decoded bit plane of the pixel location corresponding to the non-zero wavelet coefficient; or
adding the correction value on two bit planes after the last decoded bit plane of the pixel location corresponding to the non-zero wavelet coefficient.
